(19) United States
(12) Patent Application Publication
(10) Pub. No.: US 2008/0292769 A1
(43) Pub. Date: Nov. 27, 2008

(54) Method and Composition of Making Pasta with Konjac Flour as a Main Ingredient

(76) Inventors: Jill S. Tang, Livingston, NJ (US); Jin Wang, Livingston, NJ (US)

Correspondence Address: Jill S. Tang;Jin Wang, 10 Split Rock Rd, Livingston, NJ, 07039, US

(21) Appl. No.: 11/752,301

(22) Filed: May 23, 2007

(51) Int. Cl. A23L 1/16

(52) U.S. Cl. 426/557

(57) ABSTRACT

This invention discloses the method and composition of making pasta with konjac flour as a main ingredient. The composition includes konjac flour (4-12%), durum wheat flour (48-66%), and water (25-35%). The method comprises of mixing konjac flour with water, which is mixed with durum wheat flour subsequently, kneading, extruding and drying in 3 steps. The finale product has physical characters similar to that of the conventional pasta, whereas the health benefits associated with konjac is retained.

### TECHNICAL FIELD

The present invention relates to a new method of manufacturing pasta. Specifically, konjac flour is added to the conventional formulation and the new conditions of the manufacturing process are established because of the unique characters of this new ingredient. The finale product retains the claimed heath benefits associated with konjac.

### BACKGROUND OF THE INVENTION

The prevalence of obesity is rising at an alarming rate, and it is estimated that 7% of the adult population worldwide, or about 250 million people are obese (World Health Organization, 1998). Approximately two-thirds of all Americans are overweight or obese (>27 BMI), with approximately 1% having clinically severe obesity (>40 BMI) (Kuczmarski, 1994). The presence of obesity is associated with increased mortality and risk of hypertension, dyslipidemia, type 2 diabetes, coronary artery disease, stroke, gallbladder disease, osteoarthritis, sleep apnea, and cancer. On the other hand, weight loss, even at a moderate level of 5-10%, is associated with increased longevity, and improvements of many disease conditions (National Institutes of Health, 1998).

Konjac (Amorphallus Konjac K. Koch) plant is mainly distributed in the tropical region of Asia, Africa and Australia. It was reported in the ancient Chinese literature that konjac plant was used as medicine for a variety of disease conditions, and it has been a popular food in certain region in China and Japan. In the US and Europe, it is currently used as food additive to serve functions such as lubricant. Clinical studies demonstrated that treatment with konjac glucomannan, an extract from the plant, is associated with significant mean weight loss in both obese adults (Walsh et al, 1984) and obese children (Livieri et al, 1992). In addition, Konjac glucomannan also demonstrated clinical benefits in treating hyperglycemia (Chen et al, 2003), hyperlipidemia, and constipation.

There is a long history of consuming konjac food in Asia. Raw material extracted from konjac plant has been turned into “Tofu” and became ingredients in many traditional Chinese dishes. Shirataki Noodel is made of pure knack flour, and it has been a popular food in the Japanese market and was introduced to the US market in the recent years. However, the appearance, texture and taste of this high water content noodle are very different from those of the conventional pasta. It was described by consumers as “fishy” and “bouncy” while equating them as “eating a bunch of rubber bands”. It has not been accepted by the American consumers in general.

Patents of konjac glucomannan filed so far are related to the process of extracting the ingredient from the raw material, or the application as food additives. U.S. Pat. No. 3,973,008 disclosed a method of extracting konjac glucomannan from the plant by separating the soluble portion, followed by dialyzing and lyophilizing. U.S. Pat. No. 6,676,986 disclosed a method of making formed food products from food purees in which konjac was used as lubricant. U.S. Pat. No. 6,048,532 disclosed a glucomannan-containing composition for reducing cholesterol by rapid elimination of undigested fat from human body. U.S. Pat. No. 6,352,735 disclosed a method of mixing konjac flour along with other ingredients with processed meat to form low fat meat product.

Pasta is one of the most popular foods in the world. However, traditional pasta made of durum wheat has high level of carbohydrate and contributes significant portion of daily calorie. Restriction from this type of food is one of the core measurements in many weight loss programs. Pasta-lovers have a strong desire for a pasta product which can bring health benefits.

A method is described below to incorporate konjac flour to the conventional pasta formulation. In comparison to the disclosed process of the related products, innovations are made in the following area:

(A) Konjac flour is mixed with durum wheat flour as a main ingredient and the health benefits associated with konjac is retained in the final product. To our knowledge, such composition has not been disclosed.

(B) The method of mixing these two types of flours: Simply blending two types of flours will generate granules inconsistent in size, color and moisture. The method of dissolving konjac flour in water first and then apply this mixture to durum wheat flour will avoid the problem.

(C) The drying process: The typical pasta drying process will make the finale product fragile and produce low yield. The new drying process of lower temperature and longer drying periods will avoid the problem.

(D) The final product has physical properties close to the traditional pasta, in terms of the texture, taste, and elasticity. For example, it takes similar amount of time to cook the pasta with konjac flour to “al dente” perfection as compared to that of the conventional pasta.

### SUMMARY OF THE INVENTION

The present invention is a novel method of incorporating konjac flour into the conventional pasta formulation. The manufacturing process comprises the steps of: (A) mixing konjac flour with water, the amount of konjac flour is approximately 4-12% by weight of the said composition, and water is approximately 25-35% by weight of said composition; (B) mixing dissolved konjac flour with durum wheat flour, the amount of durum wheat flour is approximately 48-66% by weight of the said composition; (C) kneading; (D) extruding; (E) Phase I drying: temperature range: 70-80° C.; time: 45-60 minutes; (F) Phase II drying: temperature 60-70° C., time 60-90 minutes; (G) Phase III drying: temperature 30-40° C., time 60-180 minutes.

### DETAILED DESCRIPTION OF THE INVENTION

### Composition

Konjac flour: of high quality, the amount is approximately 4-12% by weight of said composition.

Durum wheat flour: semolina is preferred, should consist of fine particles of uniform size. The amount is approximately 48-66% by weight of said composition.

Other ingredients: egg and others, optional, usually less than 5% by weight of said composition.

Water: pure, free from off-flavor, hardness<10, PH 7.5-8.5, iron<1 mg/Kg. The amount is approximately 25-35% by weight of said composition, depending upon the amount of konjac flour used in the said composition.

### Mixing Preparation

Simply blending the two types of flours will generate granules inconsistent in size, color and moisture. The correct procedure is to add pure room temperature (15° C.-25° C.) water to konjac flour, dissolve and mix for 5-10 minutes, and rest for 2 hours. Subsequently, durum wheat flour is mixed with the dissolved konjac flour to produce dough with a moisture content of approximately 30-35%.

Eggs and other optional ingredients may also be added. At the end, make sure the size, color and moisture of the loose granules are the same.

### Kneading and Extruding

The mixture can be prepared, kneaded, and formed in any known pasta manufacturing process, using equipment such as a paddle mixer, a twin screw kneader and a single screw extruder, a twin screw mixer-kneader and a single screw extruder, or a twin screw mixer-kneader-extruder. For example, mixing can be conducted in a twin-shaft mixing chamber that rotate in opposition to pull the dough simultaneously at two directions, to minimize balling. Vacuum chamber can be used to remove air bubble. Subsequently, dough is forced through the die to form various shapes of the final products.

### Drying Process

The commonly used pasta drying temperature will make the final product fragile and of low yield. Konjac flour has strong moisture retention capacity, therefore it takes longer time to evaporate water from the surface, as well as to mobilize water from the internal layers towards the surface. Thus, the drying process is conducted at slightly lower temperature, but it requires longer time than the conventional drying process.

Temperature and time of each step need to be adjusted based on the moisture content of the product.

Immediately after extruding procedure, pasta will enter a multi-phase drying process.

(i): temperature range: 70-80° C.; time: 45-60 minutes. This phase allows a drastic reduction of the moisture in a relatively short amount of time. It should remove approximately ⅓ of water contained in the pasta, from above 30% range to below 25%.

(ii): temperature 60-70° C., time 60-90 minutes. This step aims to reduce the moisture content below 18%.

(iii): temperature 30-40° C., time 60-180 minutes. This step is to reduce the moisture content of the final pasta product below 13% and hardens the outside surface of the pasta while keeping the inside soft and plastic.

Temperature and time of drying should be adjusted based on the amount of konjac flour and shape of the finale products.

### Final Product

The final product should be firm and flexible. Comparing final products in the shape of penne, it took 11 minutes to cook to “al dente” perfection with the one made of pure semolina flour, and it took 10 minutes with the one made of both semolina and konjac flour. The taste, texture and elasticity of the cooked products are similar.

What is claimed is:

1. A process for manufacturing pasta with konjac and durum wheat flour comprises:
preparing a mixture of konjac flour, durum wheat flour and water; kneading the mixture into dough; forming the dough into a pasta; and heat treating the pasta in 3 phases
(i) Temperature 70-80° C.; time 45-60 minutes;
(ii) Temperature 60-70° C., time 60-90 minutes; and
(iii) Temperature 30-40° C., time 60-180 minutes.

2. The process of claim 1, wherein the mixture has a konjac flour content of approximately 4-12% of said composition.

3. The process of claim 1, wherein the mixture has a durum wheat flour content of approximately 48-66% of said composition.

4. The process of claim 1, wherein the mixture has a water content of approximately 25-35% of said composition.

5. The process of claim 1, wherein konjac flour is first mixed with water for 5 minutes, and then rested for 2 hours.

6. The process of claim 1, wherein durum wheat flour is mixed with pre-dissolved konjac flour with water.

7. The process of claim 1, wherein the pasta is formed by kneading and extrusion.

8. The process of claim 1, wherein the drying process is conducted in 3 phases
(i) Temperature 70-80° C.; time 45-60 minutes;
(ii) Temperature 60-70° C., time 60-90 minutes; and
(iii) Temperature 30-40° C., for 60-180 minutes.

9. The said composition used in the process of claim 1 comprising
(i) An amount of konjac flour in quantities between 4% and 12% by weight of said composition;
(ii) An amount of durum wheat flour in quantities between 48% and 66% by weight of said composition;
(iii) An amount of water in quantities between 25% and 35% by weight of said composition; and
(iv) An amount of other optional ingredients in quantities less than <5% by weight of said composition.

10. The finale product produced by the process of claim 1, wherein the physical property is similar to the conventional pasta made of durum wheat flour.
